(19) United States
(12) Patent Application Publication
(10) Pub. No.: US 2013/0038525 A1
(43) Pub. Date: Feb. 14, 2013

(54) VEHICULAR DISPLAY SYSTEM AND A METHOD FOR CONTROLLING THE DISPLAY SYSTEM

(71) Applicants: Jan Håkegård, Linkoping (SE); Anders Pettersson, Linkoping (SE); Torkel Danielsson, Linkoping (SE)

(72) Inventors: Jan Håkegård, Linkoping (SE); Anders Pettersson, Linkoping (SE); Torkel Danielsson, Linkoping (SE)

(21) Appl. No.: 13/578,661

(22) PCT Filed: Feb. 12, 2010
(86) PCT No.: PCT/SE2010/050169

§ 371 Date: Oct. 22, 2012

(51) Int. Cl. G06F 3/038; G06F 3/01

(52) U.S. Cl. 345/156; 345/204

(57) ABSTRACT

A vehicular control system including a plurality of displays each including a physical display unit and memory module including information related to descriptions of a plurality of displayable entities and first configuration data, associated to a first control module. The first configuration data including information on configuration of the displayable entities, based on references to the descriptions of the plurality of displayable entities. The memory module of each display comprises a copy of the first configuration data. The first control module is arranged to transmit data based on point-to-multipoint communication to each of the plurality of displays. The plurality of displays each includes a processor operatively coupled to the memory module. The processor is arranged to process the entities based on received data from the first control module and to present the result of the processing on the physical display unit of each of the displays.

### TECHNICAL FIELD

The present invention relates to a system and a method for controlling avionics.

Furthermore, the invention relates to software adapted to perform steps of the control method when executed on a computer.

### BACKGROUND OF THE INVENTION

In control systems of today, developments in digital technology have enabled complex functionality. However as a direct result from the development, the need of additional system capacity and functionality provided by software and various components such as sensors, processors, display units, data buses and memory units is increasing.

Real-time systems for critical control applications, wherein typically data from sensor/s are acquired, communicated and processed to provide a control signal to an actuator pose strict demands regarding bandwidth, data delivery time, redundancy, fail-safety and integrity. Failure to meet one or several of these demands can in applications including “brake-by-wire” or “steer-by-wire” prove potentially dangerous.

One such area wherein reliable high-speed real-time execution and communication of data is of outmost importance is within avionics systems. Advances in technology during late 1960 and early 1970 made it necessary to share information between different avionics subsystems in order to reduce the number of functional modules. A single sensor such as a position sensor provided information to weapon systems, display system, autopilot and navigation system.

The possibilities gained by the development within the field of computer technology have also increased the amount of processed data available to a pilot containing situation awareness information, relevant for decision making. This in combination with presentation of flight critical data, related to for example navigation, adds to the number of interactive presentations that are necessary and/or desired to provide in a cockpit display system.

Typically avionics subsystems, such as sensors, actuators, controllers and display units communicate with each other using standardized communication protocols. The commercial Aeronautical Radio Inc. (ARINC) 661, specification is a civil protocol standard for the definition of a cockpit display system and its communication with a client system arranged to manage avionics functions. Each independent client system is provided with a separate layer of a display surface. The protocol provides a safe implementation for several independent client systems to simultaneously present data on a single display surface of display system. Furthermore implementation of the ARINC 661 facilitates software certification in accordance with the Radio Technical Commission for Aeronautics (RTCA) DO-178B guidance document. Software re-certification resulting from system modifications such as additions of new client systems or modifications to the existing client systems is also facilitated.

Document US2009045981 A1 discloses a method and system for controlling data transmissions such as ARINC 661 data between at least one display and a remote client system in an avionic system.

However, the display systems according to prior art tends to require complex programming in order to provide for client systems interfacing and interacting with multiple display surfaces.

Accordingly, there is a need to present improvements in the art of avionics and displays.

### OBJECTIVE OF THE INVENTION

It is therefore an objective of the present invention to provide a system, a method and a computer program performing said method, that are less demanding to implement and which are improving flexibility in regard of interfaces between an operator and avionics.

### SUMMARY OF THE INVENTION

This objective is achieved according to the present invention by a vehicular control system. The system comprises display means each comprising a physical display unit and memory means comprising information related to descriptions of a plurality of displayable entities and first configuration data, associated to a first control module, said first configuration data comprising information on configuration of the displayable entities, based on references to the descriptions of the plurality of displayable entities. The system comprises a plurality of display means, the memory means of each display means is provided with a copy of the first configuration data, the first control module is arranged to transmit data based on point-to-multipoint communication to each of the plurality of display means, the plurality of display means each comprises processing means operatively coupled to said memory means, said processing means arranged to process the entities based on received data from the first control module, and to present the result of the processing on the physical display unit of each of the display means.

By this is achieved a system were symbolic provided by the displayable entities can be placed on any number of physical display units with a minimal amount of configuration of the displayable entities. For example, the same symbolic provided by a single portion of configuration data and an associated control module may be placed on a physical display unit located in a cockpit associated to a rear seat and a front seat of a two seated aerial vehicle.

Another beneficial contribution is that the amount of work programming a client system for a control system comprising a plurality of physical display surfaces is reduced, since there is no need for implementing separate control for each of a plurality of physical display surfaces. Furthermore the client systems may be implemented with less complexity.

The system is in one option further characterized in that the memory means of each display means is further provided with a copy of at least second configuration data, associated to at least a second control module and the processing means of each display means further are arranged to superposition the entities, associated by the first and the at least second configuration data respectively with the first and the at least second control module, on basis of predetermined hierarchical parameters associated to the first and the at least second configuration data.

By this is achieved a system that enables several different display configurations associated to different control modules to co-exist in a single display means and on a single physical display unit.

The system is in one option further characterized in that it comprises user input means, allowing a user to interact with the system.

By this is achieved a system that allows an operator of the system to monitor and control various functions of the system by providing commands affecting functions associated to at least one control module. The control module is further operable to control functions associated to a flight management computer.

The system is in one option further characterized in that it comprises interaction control means arranged to receive user inputs related to at least one of the entities and to forward the user inputs to the respective control module associated to the respective entity based on the first and second configuration data.

By this is achieved a system that allows an operator of the system to interact with the system through a displayable entity associated to a control module irrespectively of the number of physical display units and irrespectively on which of the physical display unit said displayable entity is located.

The system is in one option further characterized in that it comprises display content control means arranged to detect the first and at least second configuration data available to the plurality of display means and display mode selection means arranged to provide an operator of the system with means to activate or deactivate visualization associated to each of the available configuration data, in each of the plurality of display means.

By this is achieved a system that automatically can detect a number of available display configurations. In addition an operator of the system is provided with means during system run-time to choose desired display contents from the set of detected available display configurations.

Although the possibilities to display large amounts of data in modern display systems nowadays have increased, the implementation of a user modifiable system is not unessential, since the amount of data available to the operator could be very large which in turn affects the time of the decision process and thereby also the effectiveness of the avionics control system.

The system is in one option further characterized in that it comprises an emergency mode arranged to modify at least one display means, in order to present entities related to a minimum set of flight control surfaces and/or supervision functions required for continued vehicular operation.

By this is achieved a system that may support continued operation in case of a malfunction in the display means and/or in its associated functions.

The system is in one option further characterized in that the system is conformant with ARINC 661 specifications.

By this is achieved a system is able benefit from the ARINC 661 specifications and in addition that display content upon selection can be placed on a physical display means of choice of any number of physical display units comprised in the system.

This objective is also achieved according to the present invention by a method for controlling a vehicular system comprising the steps of providing information to the display means related to a plurality of displayable entities, providing information related to configuration of the entities by means of creating first configuration data associated with a first control module, based on references to the descriptions of the plurality of displayable entities, providing each of a plurality of display means with a copy of the first configuration data, processing the information provided to the display means in order to provide instances of the displayable entities, transmitting data from the first control module based on point-to-multipoint communication to a plurality of display means and modifying parameters of the provided instances of the displayable entities in each of the plurality of display means on basis of received data from the first control module.

The dependent claims define optional characterizing features corresponding to those described in relation to the system.

This objective is also achieved by a computer programme comprising a programme code for performing the above described method steps, when said computer programme is run on a computer.

This objective is also achieved by a computer programme product comprising a program code stored on a computer readable media for performing the above described method steps, when said computer programme is run on the computer.

This objective is also achieved by a computer programme product directly storable in an internal memory of a computer, comprising a computer programme for performing the above described method steps, when said computer programme is run on the computer.

### BRIEF DESCRIPTION OF THE DRAWINGS

FIG. 1. shows schematically a block diagram of an avionics control system according to an example of the present invention.

FIG. 2. shows schematically a block diagram of an avionics control system according to an example of the present invention.

FIG. 3. shows a flow diagram of a method for controlling avionics according to an example of the present invention.

### DETAILED DESCRIPTION

The following examples relates to the case where the control system is described with reference to aerial vehicles. However, various different applications are possible, e.g. for use in land, sea or space vehicles.

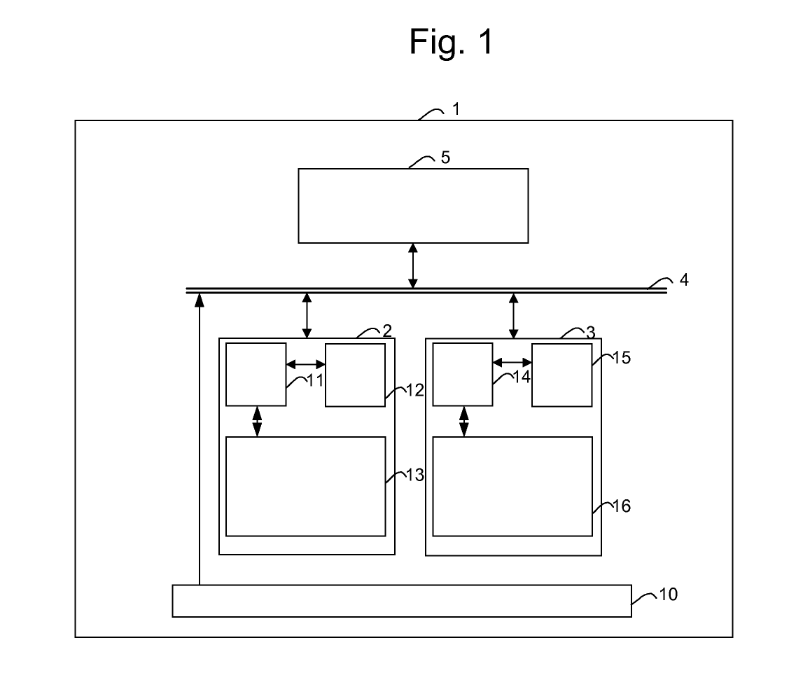

With reference to the drawings and initially to FIG. 1 an avionics control system 1, adapted to be mounted in an aerial vehicle is provided. The avionics control system 1 comprises flight displays 2, 3 arranged to provide means for at least one operator of said avionics control system 1 to interact with the system, in order to supervise and control the operation of the aerial vehicle.

In the shown example with reference to FIG. 1 the avionics control system 1 comprises two flight displays 2, 3, such as two multi functional display units

(MFDU:s). Each of the flight displays 2, 3 may comprise at least one processing device 11, 14 arranged to process data, received via a communication bus 4. The processing of the received data can be based on configuration data stored in a memory 12, 15, coupled to the processing device 11, 14. The communication bus 4 may be bi-directional and based on protocols such as the Institute of Electrical and Electronics Engineers (IEEE) Ethernet, IEEE 1394 Firewire, MIL-STD-1553, ARINC 664, ARINC 429, other protocols known in the art or any combination thereof The received data may be data transmitted from at least one flight control computer (FCC) 5 arranged to control functions of the aerial vehicle such as propulsion, flight controls, payload, hydraulics and power. The received data may be related to properties of displayable entities. The received data may comprise for example a parameter associated to a sensor reading, position of an actuator and/or a position received by an ADS-B transponder.

Thus, each processing device is arranged to process the received data based on the configuration data stored in the memory 12, 15, so as to instantiate displayable entities. Further, each processing device is in one example arranged to modify properties associated to the displayable entities on basis of the received data.

The displayable entities may be a number of predefined graphical elements, and/or grouping elements. The displayable entities may further be static, dynamic and/or interactive. Examples of displayable entities may be lines, arcs, rectangles, containers and pushbuttons. The interactive displayable entities may comprise a plurality of internal states such as in the case of the pushbutton which may comprise several graphically different states related to the when the button is in idle state, subjected to a marker passing such as a mouse-over or engaged by said marker.

As an example, a composition of the displayable entities may form a graphical representation of an altitude meter. The graphical representation of the altitude meter may comprise a plurality of graphical objects such as a circle with a plurality of evenly distributed ticks, each crossing the circle perpendicularly and associated numbering, providing an altitude scale. A pointer may be arranged to point from the centre of the circle to the current altitude provided by received data in accordance with the scale. The property of the above defined displayable entity may be related to altitude, provided from the FCC 5, which may be arranged to perform subsequent sensor readings of current altitude. Other properties of the displayable entities may be related to colouring, size and positioning

The FCC 5 may be arranged to provide data via the communication bus 4 at a periodic basis and/or based on detected events, such as event relating to when subsequent data exceed predetermined thresholds.

The communication bus 4, may in one example be a switched Ethernet network. The switched Ethernet network may comprise one or more data switches. The topology of the Ethernet network may for example be a dual redundant topology comprising two data switches and thereby also comprise two independent data paths along which data may be communicated to each device attached to the network.

In one example the communication bus 4 may be a switched Ethernet network arranged in broadcast mode, based on implementing broadcast address.

In one example the communication bus 4 may be a switched Ethernet network arranged in point-to-multipoint mode based on implementing at least one multicast address.

The configuration data stored in the memory 12, 15 comprises predetermined information relating to predetermined display content, configuration of the display content and information relating to a communication protocol. The configuration data may further comprise information related to information for interpretation of the received data such as a rendering engine. In one example the rendering may be based on OpenGL.

The flight displays 2, 3 may further each comprise at least one physical display surface 13, 16 in operable connection with the respective processing device 11, 14. The display surface 13, 16 is for example a liquid crystal display (LCD), organic light emitting diode (OLED), cathode ray tube (CRT) or any combination thereof

In one example the physical display surface 13, 16 may depending on intended use and/or physical properties be configured as a head mounted display (HMD), head down display (HDD), head up display (HUD), side display (SD), data link control display unit (DCDU) or any combination thereof.

In one example the flight displays 2, 3 comprising the physical display surfaces 13, 16 may be arranged in a vehicle control station such as in a cockpit of the aerial vehicle.

In another example one flight display 2 may be arranged in a front cockpit and the other flight display 3 may be arranged in a rear cockpit of a two seated aerial vehicle.

The flight displays 2, 3 are further configured to receive user inputs via the communication bus 4 from an operator of the avionics control system by means of at least one user interface 10. The user interface is for example at least one keyboard, mouse, joystick, trackball or rotary knob or a combination thereof The physical display surfaces 13, 16 may further comprise a resistive or capacitive touch screen layer to enable user interactions.

The flight displays 2, 3 may further be arranged to forward received user inputs to the FCC 5, in order for the FCC 5 to respond to user inputs. As an example the operator may detect that a parameter associated with a sensor reading of a specific engine component exceeds a predetermined temperature threshold and respond accordingly, by providing a command counteracting the condition. The counteracting command comprises for example providing an actuator of an engine cooling system with a command to increase cooling efficiency.

In one example the flight displays 2, 3 may be assigned to visualising either a primary flight display (PFD) or a Navigation display (ND). The PFD may be arranged to visualize indicators relating to characteristics of the aerial vehicle hosting the control system 1, such as for example air speed, attitude, altitude and/or magnetic heading. The ND may be arranged to visualize indicators relating to characteristics of the aerial vehicle hosting the control system 1, such as for example map, flight path and other aerial vehicles detected in the surrounding air space.

In another example at least one of the flight displays 2, 3 may be assigned to simultaneously visualising both a PFD and a ND.

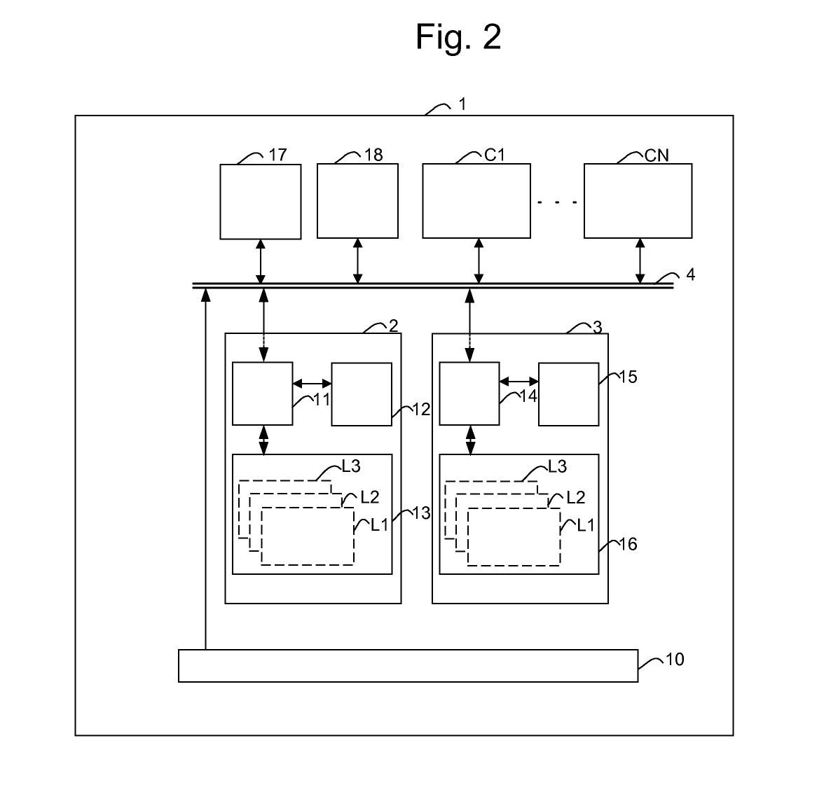

In one example explained with reference to FIG. 2, the processing devices 11, 14 of the control system 1 may be arranged to process a predetermined library of displayable entities and a number of configuration files, also referred to as definition files, stored in the memory 12, 15. The predetermined library of displayable entities may comprise a predetermined list of displayable entities with associated descriptions relating to graphic appearance and behaviour. The definition files may each comprise configuration information relating to a selection of displayable entities to instantiate with associated initial properties. Each of the definition files may comprise information describing the displayable entities, constituting each of a set of layers L1-L3, displayable in the physical display surfaces 13, 16 of the flight displays 2, 3. By processing the definition files, a set of layers L1-L3 each comprising one or more specific instances of the displayable entities may be provided in each of the physical display surfaces 13, 16. A number of client systems C1-CN may be arranged to handle the logic of the displayable entities. The handling of the logic may comprise determining and providing the parameters associated to the properties of the instantiated displayable entities during system run-time. As an example one or more of the client systems C1-CN may be arranged to provide one or more of the instantiated displayable entities with properties related to sensor readings or positions of actuators. As an example, the logic of one of the client systems C1-CN may be arranged to alter colour of one of its associated instantiated displayable entities upon detection of an intruding aerial vehicle breaching a proximity threshold. Each of the number of client system C1-CN may be associated to one or more of the layers L1-L3. Each of the layers L1-L3 may be associated to one of the client systems C1-CN.

It is to be understood that the exemplified number of layers L1-L3, available to the system 1 is by no means limited to three. The system 1 may as well comprise at least as many of the layers as the corresponding number of available client systems C1-CN, determined to have a need for displaying information.

In one example each of the client systems C1-CN may be arranged to transmit data to the flight displays 2, 3, using point-to multipoint communication wherein said data may be related to the properties of the instantiated displayable entities. The client systems C1-CN may be implemented in software and hosted on one or more avionics computers such as the FCC 5.

By transmitting data based point-to-multipoint i.e. multicasting data to the flight displays 2, 3 associated to properties of the displayable entities associated to the respective layers L1-L3, the operation of adding one or several flight displays 2, 3 to the control system 1 is simply to provide the predetermined library of displayable entities and duplicates of the pre-existing definition files to the memory of the additional one or more flight displays. Hence, there is no need for modifications of the existing client systems C1-CN in connection to adding additional flight displays 2, 3 to the existing system 1.

In one example the definition files may be created using the format extensible mark-up language (XML), on basis of the ARINC 661 specifications. The definition files may further be compiled from the XML format to binary and subsequently uploaded to the memory 12, 15 of the flight display 2, 3.

In one example the predetermined library of displayable entities may be based on the widget library as defined by the ARINC 661 specifications.

In one example the definitions of the client systems C1-CN may be based on user applications (UA) as defined by the ARINC 661 specifications.

In one example a display server can be provided in the control system 1. The display server may provide a set of services related to handling of user input data, instantiating displayable entities and handling of hierarchy of the displayable entities on basis of the configuration data. The display server may be implemented in software executed on the processing devices 11, 14 of the flight displays 2, 3. The operating instructions for the display server may be provided by information stored on the memory 12, 15.

In one example with reference to FIG. 2 a mode control unit 17 is provided in the avionics control system 1. The mode control unit 17 is arranged to receive data messages related to user inputs. In response to specific user inputs the mode control unit 17 can be arranged to transmit a data message to a display server, related to controlling a visibility parameter associated to the respective layers L1-L3. The mode control unit 17 may be a centralized unit implemented in software as a user application. The mode control unit 17 may further be adapted to the ARINC 661 specification.

As an example a first 2 and a second flight display 3 may be configured to each display a set of three stacked i.e. super positioned layers L1-L3. A first layer L1 and a second layer L2 of the set of stacked layers L1-L3, may be associated to one or more of the displayable entities, forming a PFD. A third layer L3 may be associated to one or a composition of the displayable entities constituting a ND. The second layer L2 may be assigned with a background fill colour. The order of visibility of the layers may be hierarchically defined from L1-L3. The parameters referring to hierarchically defined order of visibility/relative visibility between layers may be statically specified in the respective definition file associated to the respective layer L1-L3. Apart from the order of visibility, each layer L1-L3 may comprise a parameter associated to absolute visibility, with selectable values TRUE or FALSE. Thus, with the visibility parameter set to TRUE on all the layers L1-L3, only the PFD will be visible to the operator and the ND will not be seen. By providing a user input associated to the mode control unit 17, for example by using the keyboard device 10, the mode control unit 17 may in response be arranged to transmit a message, informing a display server associated to the first flight display 2 to set the visibility parameter of the first L1 and second L2 layers to FALSE. By manipulating the visibility of the first L1 and second L2 layers, only the ND and not the PFD will be seen by the operator in the first flight display 2.

In one example the at least one operator is provided with a predetermined selection of display modes. The selection of predetermined display modes may be preconfigured by means of arranging instances of displayable entities associated to the stacked layers L1-L3 into one or more of a plurality of portions. The plurality of portions may correspond to different display areas within the respective physical display surface 13, 16. Thus, by positioning instances of displayable entities from more than one of the layers into the same portion, the visibility of the instances of displayable entities may be controlled locally within each portion by means of the absolute visibility associated to each layer.

The portions may in one example correspond to rectangular portions of the physical display surface. Each of the portions may further be divided into a plurality of sub portions.

As an example the instances of displayable entities associated with a first client system C1, through the respective definition file to the first layer L1 may be assigned to a first portion of the first layer L1 corresponding to a first portion of the physical display surface 13, 16. The first portion may correspond to a display area covering the lower half of the available display surface of the respective physical display surface 13, 16. The instances of displayable entities associated with a second client system C2, through the respective definition file to the second layer L2 may be assigned to a second portion of the second layer L2 corresponding to a second portion of the physical display surface 13, 16. The second portion may correspond to a display area covering the upper half of the available display surface of the respective physical display surface 13, 16. The instances of displayable entities associated with a third client system C3, through the respective definition file to the third layer L3 may also be assigned to the second portion of the third layer L3 corresponding to the said second portion of the physical display surface 13, 16. Thus, the instances of the displayable objects associated to the second and third layer L2, L3 overlap in the second portion of the respective physical display surface 13, 16. The visibility of the instances associated to the second and third layer L2, L3 is then in default mode controlled by the hierarchy parameters defining order of visibility associated to the respective layer and may subsequently be modified by controlling the absolute visibility of each of the respective overlapping layers. The instances associated to the first layer L1 does not affect the visibility or become affected by modifications of the visibility associated to either of the second and/or third layer L2, L3, due to being positioned in another display portion namely the first portion.

Accordingly, the at least one operator will be given the predetermined selection of display modes comprising a first and a second display mode. The first display mode corresponding to visualize the instances of displayable entities associated to the first layer L1 in the first portion and to visualize the instances of displayable entities associated to the second layer L2 in the second portion. The second display mode corresponding to visualize the instances of displayable entities associated to the first layer L1 in the first portion and to visualize the instances of displayable entities associated to the third layer L3 in the second portion. The desired display configuration may then be selected by means of the input device.

It is to be noted that the number of different display portions may differ from the example above. The number of different layers L1-L3 with associated instances of displayable entities designated to be positioned in each portion may further vary.

In one example the at least one operator is provided dynamic selection of display modes. As an example the dynamic selection may implemented by means of that the displayable entities of each layer may be assigned to a dynamic portion of the layer corresponding to a dynamic portion of the physical display surface 13, 16. The term dynamic refers herein to that the position and/or size of the portion may be modified during system run-time such as by means of the operator interacting with the system using the input device 10. By use of the dynamic portion the at least one operator may be given the selection of which of the available display content is to be presented where and on which of the available physical display surfaces 13, 16.

In one example the at least one operator is provided with a selection where at least one dedicated portion of the available physical display surfaces 13, 16 are arranged to present displayable entities associated to the graphical representation of the PFD irrespective of the selection from the at least one operator.

In one example a display content module is provided in the avionics control system 1. The display content module may be implemented as part of the mode control unit 17. The display content module may be arranged to register the definition files available to each flight display 2, 3. The display content module may be arranged to determine the associated client system C1-CN and the respective functionality associated to the respective client system C1-CN from the registered definition files. The information from the registered definition files may then be compiled and subsequently used to provide basis for the selection by means of the mode control unit 17 of desired display content provided to the at least one operator.

In one example an event concentration unit 18 is provided in the avionics control system 1. The event concentration unit 18 is arranged to receive all data messages via the communication bus 4 related to user inputs, also referred to as events from a plurality of flight displays 2, 3. The display server of each flight display 2, 3 may be arranged to transmit all data messages related to the events to the event concentration unit 18. Upon receipt of the data messages related to user inputs, the event concentration unit 18 may be arranged to detect an identity of the intended receiving client system C1-CN associated to the data message and to forward the respective data message to the correct client system C1-CN. The event concentration unit 18 may be a centralized unit implemented in software. The event concentration unit 18 may in one example be arranged to identify the client system C1-CN associated to the respective instantiated displayable entity issuing the event based on information provided in the data message on basis of ARINC 661 protocol. The event concentration unit 18 may further be arranged to reside inside the FCC 5.

The concentration unit 18 may in one example be arranged prioritize between user inputs, with origin from user interaction with one and the same instantiated displayable entity, duplicated to several flight displays 2, 3. Said prioritization may be based on order of message arrival or statically assigned priorities assigned to different flight displays 2, 3 intended for a pilot and a co-pilot.

By implementing the event concentration unit 18, user interactions may be correctly transmitted to the associated client system C1-CN irrespective of the number of available flight displays, client systems C1-CN and/or the number of operators.

In one example the client systems C1-CN may be hosted on at least one avionics computer compliant with ARINC 653, specifications. The client systems C1-CN and/or event concentration unit 18 and mode control unit 17 may further be hosted on separate partitions of the at least one avionics computer such as the FCC 5.

In one example, the above described functions related to the processing devices 11, 14 and the respective memory 12, 15 may reside in separate partitions of the at least one avionics computer, compliant with ARINC 653, specifications.

In one example an emergency display mode may be provided in the control system 1. The emergency display mode can be arranged to modify the appearance of displayable entities of a least one of the flight displays 2, 3.

The emergency mode may be arranged to modify the appearance of the flight displays 2, 3 to correspond to a minimum set of flight control surfaces and supervision functions required for continued vehicular operation, in case of a display failure. The emergency mode may further be arranged to modify the appearance of displayable entities of a least one of the flight displays 2, 3 irrespective of the visible display objects prior to activation.

The emergency mode can manually be activated by a pilot pressing an activation button in response to detecting failure of one or more of the flight displays 2, 3. Alternatively the emergency mode may be activated automatically by the control system 1 detecting a fault condition.

To provide for a safe implementation of the emergency mode, it may be implemented in software as a separate emergency partition of an ARINC 653 compliant computing system such as on the FCC 5 or alternatively implemented in dedicated hardware. The emergency mode may further be provided with a separate communication link to associated avionics subsystems providing necessary minimum set of flight control and supervision functions. The separate communication link may be point to point links such as RS-485 or ARINC 429. By activating the emergency mode a switchover to the separate emergency partition and respective separate communication link is made i.e. communication, hardware and/or software related failures are circumvented, by means of using different hardware and software.

In one example the avionics control system 1 may be configured to be compatible with industry standard specifications such as the ARINC 661, cockpit display interface specifications.

In one example the processing devices 11, 14 may comprise a non-volatile memory, a data processing device such as a microprocessor and a read/write memory. The non-volatile memory has a first memory portion wherein a computer program, such as an operating system, is stored for controlling the function of the system 1. Further, the processing device 11, 14 comprises a bus controller, a serial communication port, I/O-means, an A/D-converter, a time date entry and transmission unit, an event counter and an interrupt controller. The non-volatile memory also has a second memory portion.

A computer program comprising routines for controlling the system 1 of an aerial vehicle is provided. The program may be stored in an executable manner or in a compressed state in a separate memory and/or in the read/write memory.

When it is stated that the data processing device performs a certain function it should be understood that the data processing device performs a certain part of the program which is stored in separate memory, or a certain part of the program which is stored in read/write memory.

The data processing device may communicate with a data port by means of a first data bus. The non-volatile memory is adapted for communication with the data processing device via a second data bus. The separate memory is adapted to communicate with data processing device via a third data bus. The read/write memory is adapted to communicate with the data processing device via a fourth data bus.

When data is received on the data port it is temporarily stored in the second memory portion. When the received input data has been temporarily stored, the data processing device is set up to perform execution of code in a manner described above. According to one example, data received on the data port comprises information regarding properties associated to instances of displayable entities from the flight management computer 5 and/or configuration data from the memory storage device 12, 15 and/or user inputs from the user input device 10. This information can be used by the processing device 11, 14 so as to provide each of a plurality of flight displays 2, 3 with updated parameters associated with properties of instantiated displayable entities and to provide modification of display content and/or layout during system run-time as described above.

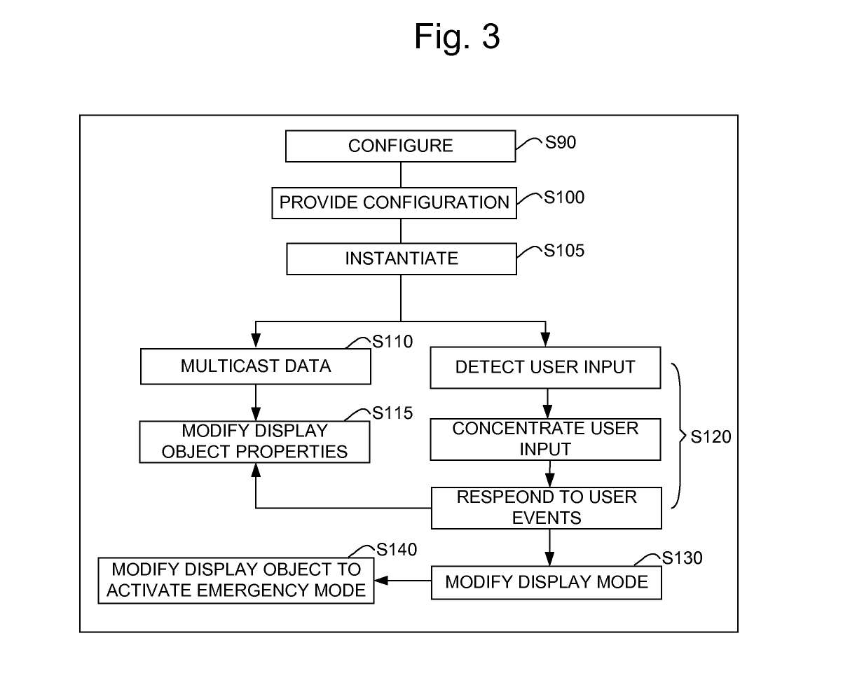

An example of the invention relates to a computer programme comprising a programme code for performing the method steps depicted with reference to FIG. 3, when the computer programme is run on a computer.

An example of the invention relates to a computer programme product comprising a program code stored on computer-readable media for performing the method steps depicted with reference to FIG. 3, when the computer programme is run on the computer.

An example of the invention relates to a computer programme product directly storable in an internal memory of a computer, comprising a computer programme for performing the method steps depicted with reference to FIG. 3, when the computer programme is run on the computer.

FIG. 3 schematically illustrates an example of a control method for a vehicular system. This example relates to provide a plurality of flight displays 2, 3 each containing displayable entities with continuously updated parameters and to provide means for run-time modification of display content and/or layout.

In a first method step s90 display content is configured off-line by defining a set of displayable entities, constituting a library of displayable entities. The display content are further configured by providing display layers L1-L3, defined by definition files comprising a number of references with associated initial properties to displayable entities defined by the library of displayable entities. Each layer are further associated to one client system C1-CN each. After the method step s90 a subsequent method step s100 is performed.

In the method step s100 information are provided to the memory 12, 15 by upload of the library of predetermined displayable entities and the display configuration files. After the method step s100 a subsequent method step s105 is performed.

In the method step s105 the information provided by the at least one definition file and the predetermined library of displayable entities stored in the memory are processed by the processing device 11, 14 i.e. instances of the displayable entities as described by the predetermined library of displayable entities are created according to the configurations provided by each of the definition files. After the method step s105 a subsequent method step s110 is performed.

In the method step s110 data from the at least one control module C1-CN is transmitted based on point-to-multipoint communication to a plurality of display means 2, 3, in response to changes in the at least one parameter of the at least one control module C1-CN. After the method step s110 a subsequent method step s115 is performed.

In the method step s115 instances of the objects are modified in each of the plurality of the flight displays on basis of the received data from the at least one client system C1-CN. After the method step s115 the method step s110 is repeated to continuously update properties of the instanced displayable entities.

In one example the method step s110 of transmitting data data from the at least one control module C1-CN to a plurality of flight displays 2, 3, is performed in response to changes in at least one parameter of the at least one client system C1-CN and/or on a periodic basis.

In one example, a further method step s120 is performed. In the method step s120 data messages related to user input are transmitted by means of the display server and subsequently received in the event concentration unit 18.

An intended receiving client system C1-CN is detected from received data messages by the event concentration unit 18 controlling the identity associated to one of the client system C1-CN of the instanced displayable entity issuing the user input as a result of the at least one operator interacting with said displayable entity instance. The data message is then forwarded to the detected intended receiving client system C1-CN in order for the client system C1-CN to respond according to its predetermined logics.

In one example, a further method step s130 is performed. In the method step s130 the configuration files available to the plurality of flight displays 2, 3 are detected by means of display content control means. The at least one operator of the system is then provided with means to select display content provided by display mode selection means 17. The respective instanced displayable objects associated to the detected available configuration files are then presented on basis of the selected display content in each of the plurality of flight displays 2, 3 and/or on the respective flight display 2, 3 where the selection were performed.

In one example, a further method step s140 is performed. In the method step s140 an emergency mode is activated in response to detecting a malfunction in the control system 1. The emergency mode is activated in order to present objects related to a minimum set of flight control surfaces and supervision functions required for continued vehicular operation in the at least one flight display 2, 3.

Many modifications and variations will be apparent to practitioners skilled in the art without departing from the scope of the invention as defined in the appended claims. The examples were chosen and described in order to best explain the principles of the invention and its practical applications, thereby enabling others skilled in the art to understand the invention for various examples and with various modifications as suited to the particular use contemplated.

1-13. (canceled)

14. A vehicular control system, the system comprising:
a plurality of display each comprising a physical display unit and a memory unit comprising information related to descriptions of a plurality of displayable entities and first configuration data associated with a first control module, said first configuration data comprising information on configuration of the displayable entities, based on references to the descriptions of the plurality of displayable entities;
a display content control arranged to detect the first and at least second configuration data available to the plurality of displays; and
a display mode selector arranged to permit an operator of the system to activate or deactivate visualization associated to each of the available configuration data, in each of the plurality of displays,
wherein the memory unit of each display comprises a copy of the first configuration data,
wherein the memory unit of each display further comprises a copy of at least second configuration data, associated to at least a second control module,
wherein the first and second control modules are arranged to transmit data based on point-to-multipoint communication to each of the plurality of the display, and
wherein the plurality of displays each comprise a processor operatively coupled to the memory unit, wherein said processor is arranged to process the entities based on received data from the first and second control modules, and to present the result of the processing on the physical display unit of each of the displays.

15. The system according to claim 14, wherein the processor of each display is further arranged to superposition the entities, associated by the first and the at least second configuration data respectively with the first and the at least second control module based on predetermined hierarchical parameters associated to the first and the at least second configuration data.

16. The system according to claim 14, further comprising:
a user input configured to permit a user to interact with the system.

17. The system according to claim 16, further comprising:
an interaction control unit arranged to receive user inputs related to at least one of the entities and to forward the user inputs to the respective control module associated with the respective entity based on the first and at least second configuration data.

18. The system according to claim 14, further comprising:
an emergency mode arranged to modify at least one display in order to present entities related to a minimum set of flight control surfaces and/or supervision functions required for continued vehicular operation.

19. The system according to claim 14, wherein the system conforms with ARINC 661 specifications.

20. A method for controlling a vehicular system, the method comprising:
providing information to a display related to a plurality of displayable entities;
providing information related to configuration of the entities by creating first configuration data associated with a first control module, based on references to the descriptions of the plurality of displayable entities;
providing each of a plurality of displays with a copy of the first configuration data;
providing a memory module in each of the plurality of displays with a copy of at least second configuration data associated with at least a second control module;
processing the information provided to the displays in order to provide instances of the displayable entities;
transmitting data from the first and second control modules based on point-to-multipoint communication to the plurality of displays;
modifying parameters of the provided instances of the displayable entities in each of the plurality of displays based on received data from the first and second control modules;
detecting the first and the at least second configuration data available to the plurality of displays by a display content control;
compiling the display content into a plurality of selectable display modes, based on the detection of the configuration data;
providing an operator of the system with a display content selector to select display content provided by a display node selector; and
presenting the entities associated to the detected available configuration files, in each of the plurality of displays based on the selected display content.

21. The method according to claim 20, wherein the transmitting of data from the first control module based on point-to-multipoint communication to the plurality of displays is performed in response to changes in at least one parameter of the first control module and/or on a periodic basis.

22. The method according to claim 20, further comprising:
receiving data related to user input in an interaction control;
detecting in the received data an intended receiving control module based on the first and at least second configuration data; and
forwarding the data message to the intended receiving control module in order for the control module to respond accordingly.

23. The method according to claim 20, further comprising:
activating an emergency mode in response to detection of malfunction, wherein the display content of at least one of the plurality of displays is modified so as to present entities related to a minimum set of flight control surfaces and/or supervision functions required for continued vehicular operation.

24. A computer program product, comprising:
a non-transitory computer readable medium; and
computer program instructions recorded on the computer readable medium for carrying out a method for controlling a vehicular system, the method comprising:
providing information to a display related to a plurality of displayable entities;
providing information related to configuration of the entities by creating first configuration data associated with a first control module, based on references to the descriptions of the plurality of displayable entities;
providing each of a plurality of displays with a copy of the first configuration data;
providing a memory module in each of the plurality of displays with a copy of at least second configuration data associated with at least a second control module;
processing the information provided to the displays in order to provide instances of the displayable entities;
transmitting data from the first and second control modules based on point-to-multipoint communication to the plurality of displays;
modifying parameters of the provided instances of the displayable entities in each of the plurality of displays based on received data from the first and second control modules;
detecting the first and the at least second configuration data available to the plurality of displays by a display content control;
compiling the display content into a plurality of selectable display modes, based on the detection of the configuration data;
providing an operator of the system with a display content selector to select display content provided by a display node selector; and
presenting the entities associated to the detected available configuration files, in each of the plurality of displays based on the selected display content.
